(19) United States
(12) Patent Application Publication
(10) Pub. No.: US 2024/0271651 A1
(43) Pub. Date: Aug. 15, 2024

(54) Drywall Fastening Button Device

(71) Applicant: Jeremy Shaw, Victoria Harbour (CA)

(72) Inventor: Jeremy Shaw, Victoria Harbour (CA)

(21) Appl. No.: 18/108,482

(22) Filed: Feb. 10, 2023

(51) Int. Cl. F16B 15/06

(52) U.S. Cl. CPC F16B 15/06

(57) ABSTRACT

A drywall fastening button device may be provided that utilizes a retention button portion having an upper lip, a button portion and a retaining wall. The retaining wall may surround the button portion and the upper lip may be disposed at a top terminal end of the retaining wall. The retention button portion may utilize a nail element portion having a shaft portion, a plurality of back hooks and a pointed tip end. The shaft portion may extend from the retention button portion. The plurality of back hooks may extend outward from the shaft portion. The pointed tip end may be disposed at a bottom terminal end of the nail element portion.

### BACKGROUND OF THE INVENTION

Nearly every new residential and commercial construction project utilizes the installation of drywall given the ubiquity of its use in all modern building fabrication. To that end, the drywall installation industry is estimated domestically to be valued in the tens of billions of dollars and to employ tens of thousands of workers. The process of installing drywall within a building under construction can be a very time-consuming portion and thereby a costly portion of the overall construction process. Specifically, each screw requires the installation specialist to use two hands to install the screw which inherently is more inefficient than a process only requiring one hand. Therefore, it would be advantageous to provide a means of installing drywall screws with only one hand and expediting the drywall installation process without sacrificing the quality of the installation.

During the drywall installation process, construction companies and contractors use drywall screws to secure the panels of drywall to the studs of the building frame. Unfortunately, it is relatively common for these screws to pop out from their securement to the studs. While the drywall screw may be embedded deeply into the drywall panel, the screw may come loose over time and pop out of its securement to the stud which causes the drywall panel to appear popped out therefrom.

There are many contributing factors to drywall popping, but the most common reasons involve the drywall screw being installed too deep into the stud and/or the studs physically expanding and contracting due to repeated changes in moisture and/or temperature. A deeply driven drywall screw can put undue resistive force on the screw due to the refractory force of the drywall panel attempting to attain structural equilibrium. Expansion and contraction of the drywall stud slowly erodes the press-fit engagement between the screw and the stud which causes the screw to come loose.

Specifically, if a drywall screw is driven too deep through the drywall and into the stud, it may cause the drywall panel to pop out. Typical drywall panels are covered in a thin layer of material similar to that of paper. When a drywall screw is driven too deep into the stud then it will likely break the thin paper covering which can cause the drywall screw to have a weaker coupling to the stud and thereby may lead to it popping out.

Further, drywall screws can also pop out of drywall due to repetitive expansion and contraction of studs to which it is being coupled. Since studs are made of wood, they will expand and contract due to alterations in their surrounding environment. For instance, a humid environment will cause studs to absorb moisture and expand in volumetric dimension. A change in season to a dry environment will cause the studs to release the moisture and contract in volumetric dimension. Over time, this repeating contraction and expansion in volumetric dimension of studs increases the likelihood that drywall screws will pop out.

Traditional methods for preventing drywall screws and panels from popping out involve driving the screws a precise amount into the drywall panel and controlling the humidity level of the external environment with a device like a dehumidifier. However, a drywall panel may require roughly 30 or more screws per panel and so taking the time to precisely drive each screw into the given panel is both not realistic given human error and extremely time-consuming. Further, use of an external device such as a dehumidifier is both inconvenient and impractical as not every building occupant will be able to utilize a dehumidifier and, if they can, it is a burden to maintain proper functionality of such a device over the lifespan of the drywall panels.

Therefore, it would be advantageous to provide a drywall fastening button device that increases the likelihood of the drywall screw and panel maintaining firm securement to the stud without the need for inhuman precision by the installation specialist or external humidity-regulating machines by the building occupant. Specifically, it would be advantageous to provide a drywall fastening button device comprising a nail shank having a plurality of back hooks extending therefrom in order to maintain tight securement to the stud regardless of external factors such as drive depth and stud expansion and contraction. Further, it would be advantageous to provide a drywall fastening button device comprising a retention button disposed over the nail head that may be driven into the outer surface of the drywall panel in order to provide an additional means of securement between the drywall panel and the stud which further prevents pop out.

### BRIEF DESCRIPTION OF THE DRAWINGS

FIG. 1 illustrates an elevational view of a drywall button gun for dispensing a plurality of drywall button fasteners in accordance with some embodiments of the present invention.

FIG. 2A illustrates a top perspective view of a drywall button fastener in accordance with some embodiments of the present invention.

FIG. 2B illustrates an elevational view of a drywall button fastener in accordance with some embodiments of the present invention.

FIG. 2C illustrates a cross-sectional view of a drywall button fastener coupling a drywall panel to a stud in accordance with some embodiments of the present invention.

FIG. 2D illustrates a bottom perspective view of a drywall button fastener in accordance with some embodiments of the present invention.

FIG. 2E illustrates a partial cross-section elevational view of a drywall button fastener in accordance with some embodiments of the present invention.

FIG. 3 illustrates a detailed elevational view of the interior of a magazine of a drywall button gun for dispensing a plurality of a drywall button fasteners in accordance with some embodiments of the present invention.

FIG. 4A illustrates an elevational view of a nail element portion of a drywall button fastener having cylindrical back hooks in accordance with some embodiments of the present invention.

FIG. 4B illustrates a perspective view of a nail element portion of a drywall button fastener having cylindrical back hooks in accordance with some embodiments of the present invention.

### DETAILED DESCRIPTION OF THE INVENTION

Before describing the present invention in detail, it is to be understood that the invention is not limited to any one of the particular embodiments, which of course may vary. It is also to be understood that the terminology used herein is for the purpose of describing particular embodiments only, and therefore is not necessarily intended to be limiting. As used in this specification and the appended claims, terms in the singular and the singular forms “a,” “an,” and “the” include plural referents unless the context clearly dictates otherwise. Thus, for example, reference to “a drywall fastening button device” also includes a plurality of drywall fastening button devices and the like.

In some embodiments, a drywall fastening button device is provided comprising a retention button portion comprising an upper lip, a button portion and a retaining wall, wherein: the retaining wall surrounds the button portion, and the upper lip is disposed at a top terminal end of the retaining wall; and a nail element portion comprising a shaft portion, a plurality of back hooks and a pointed tip end, wherein: the shaft portion extends from the retention button portion, the plurality of back hooks extend outward from the shaft portion, and the pointed tip end is disposed at a bottom terminal end of the nail element portion.

In some embodiments, the retention button portion and the nail element portion are robustly coupled together via the shaft portion.

In some embodiments, the retention button portion and the nail element portion are robustly coupled together via a nail head of the nail element portion.

In some embodiments, the retention button portion and the nail element portion each comprise identical metallic fabrication materials.

In some embodiments, the retention button portion comprises a polymer fabrication material and the nail element portion comprises a brittle steel fabrication material.

In some embodiments, the retention button portion and the nail element portion are fabricated from the same material together as a monolithic seamless unitary structure.

In some embodiments, the retention button portion comprises a bottom surface.

In some embodiments, the retaining wall comprises an interior wall surface.

In some embodiments, a cavity is defined by the bottom surface and the interior wall surface.

In some embodiments, the shaft of the nail element portion passes through the cavity.

In some embodiments, a nail head of the nail element portion is disposed within the bottom surface.

In some embodiments, the shaft portion comprises a shank disposed between a bottom surface of the retention button portion and the plurality of back hooks.

In some embodiments, the plurality of back hooks are disposed between the shank and the pointed tip end.

In some embodiments, a plurality of shank spacer portions are disposed axially along the shaft portion between successive back hooks of the plurality of back hooks.

In some embodiments, a first retention button portion of a first drywall fastening button device is coupled to a second retention button portion of a second drywall fastening button device.

In some embodiments, the first retention button portion and the second retention button portion are fabricated from the same material together as a monolithic seamless unitary structure.

In some embodiments, the first retention button portion and the second retention button portion are coupled together via a breakaway coupling segment.

In some embodiments, the second retention button portion is coupled to a third retention button portion of a third drywall fastening button device; and the second retention button portion is disposed in series between the first retention button portion and the third retention button portion.

In some embodiments, a drywall fastening button device is provided comprising a retention button portion comprising an upper lip, a button portion and a retaining wall, wherein: the retaining wall surrounds the button portion, and the upper lip is disposed at a top terminal end of the retaining wall; and a nail element portion comprising a shaft portion, a plurality of back hooks and a pointed tip end, wherein: the shaft portion extends from the retention button portion, the plurality of back hooks extend outward from the shaft portion, the pointed tip end is disposed at a bottom terminal end of the nail element portion, and the shaft portion comprises a shank disposed between a bottom surface of the retention button portion and the plurality of back hooks.

In some embodiments, a drywall fastening button device is provided comprising a retention button portion comprising an upper lip, a button portion and a retaining wall, wherein: the retaining wall surrounds the button portion, and the upper lip is disposed at a top terminal end of the retaining wall; and a nail element portion comprising a shaft portion, a plurality of back hooks and a pointed tip end, wherein: the shaft portion extends from the retention button portion, the plurality of back hooks extend outward from the shaft portion, the pointed tip end is disposed at a bottom terminal end of the nail element portion, the shaft portion comprises a shank disposed between a bottom surface of the retention button portion and the plurality of back hooks, the plurality of back hooks are disposed between the shank and the pointed tip end, and a plurality of shank spacer portions are disposed axially along the shaft portion between successive back hooks of the plurality of back hooks.

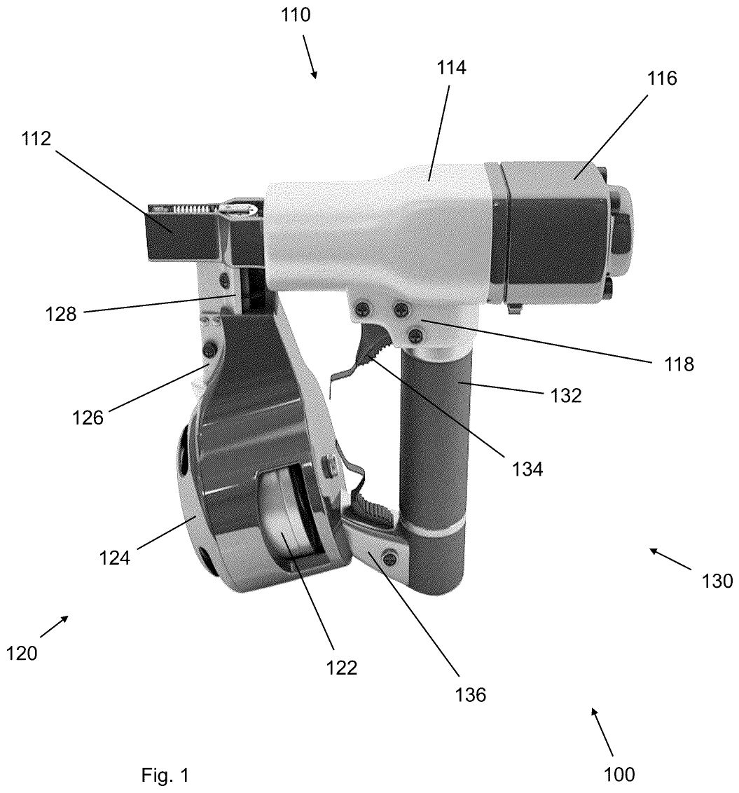

Exemplary embodiments of the present invention are illustrated in the accompanying figures. As shown in FIG. 1, an elevational view of a drywall button gun 100 for dispensing a plurality of drywall button fasteners is provided. The drywall button gun 100 may comprise an ejection portion 110, a magazine portion 120 and a handle portion 130. The ejection portion 110 may be coupled to each of the magazine portion 120 and the handle portion 130 and, further, may be disposed in a horizontal manner across the top of both of the magazine and handle portions 120, 130.

The ejection portion 110 may comprise an ejection port 112, an anvil housing 114, a fluid compressor housing 116 and a trigger coupling portion 118. The ejection port 112 may be coupled at a proximal end to a distal end of the anvil housing 114. The anvil housing 114 may be coupled at a proximal end to a distal end of the fluid compressor housing 116. The anvil housing 114 may be coupled at a bottom surface to the trigger coupling portion 118 as shown in FIG. 1.

The magazine portion 120 may comprise a drywall button fastener magazine 122, a magazine housing 124, a coupling portion 126 and a loading chamber 128. The drywall button fastener magazine 122 may be removably disposed within the magazine housing 124. The magazine housing 124 may be coupled to the ejection port 112 of the ejection portion 110 via the coupling portion 126. Further, the magazine housing 124 may couple to the loading chamber 128 at a top portion thereof as shown in FIG. 1. Additionally, the magazine housing 124 may be structurally coupled to the loading chamber 128 in order to pass drywall button fasteners from the magazine 122 to the ejection port 112 via the loading chamber 128 for striking by the anvil contained within the anvil housing 114 which ultimately leads to ejection of a drywall button fastener from the gun 100.

The handle portion 130 may comprise a handle 132, a trigger 134 and a support coupling 136. The handle 132 may extend downward from the trigger coupling portion 118 of the ejection portion 110 at a top terminal end and may couple to the support coupling 136 at a bottom terminal end. The trigger 134 may be secured in place via the trigger coupling portion 118 and may extend into the inner cavity formed between each outer surface of the ejection portion 110, the magazine portion 120 and the handle portion 130. The support coupling 136 may couple the magazine housing 124 to the handle 132 in order to provide robust structural support for the gun 100 during use thereof by a user.

In operation, a drywall button fastener disposed within an ejection chamber of the ejection portion 110 will be expelled out of the ejection port 112 via an anvil contained within the anvil housing 114 that is propelled by fluid pressure generated and delivered by a fluid compressor contained within the fluid compressor housing 116. Upon ejection of the first fastener by user-actuation of the trigger 134, the anvil actuates a slide reload mechanism that utilizes a rotary feed mechanism within the loading chamber 128 which is fed spring-loaded fasteners from the magazine 122, thereby allowing successive fasteners to be automatically fed into the ejection chamber in an interactive manner until the magazine 122 runs out of fasteners.

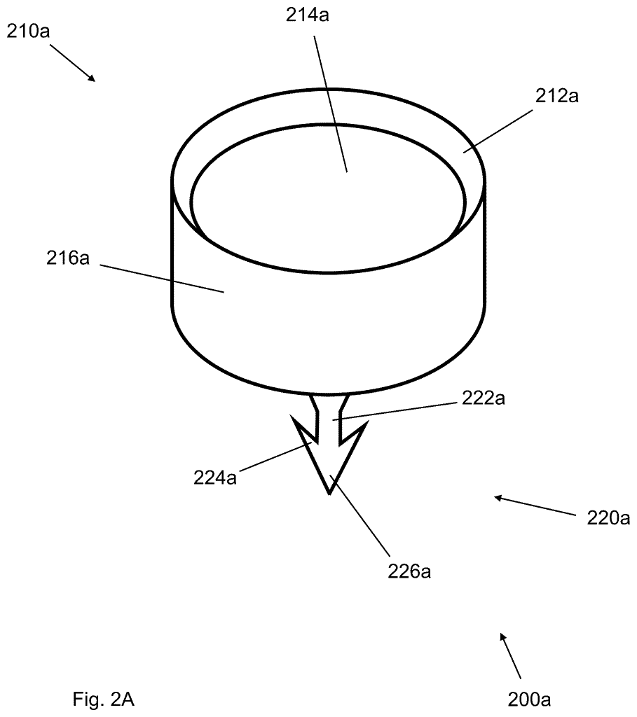

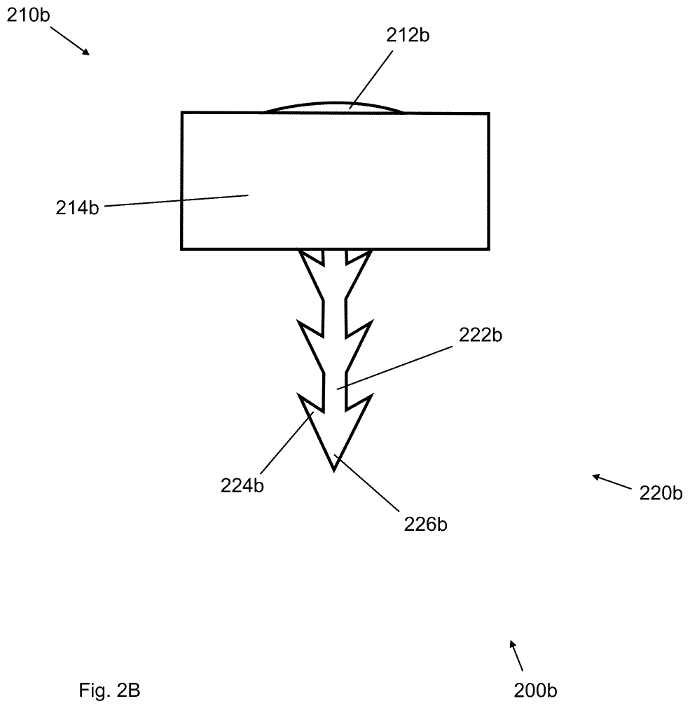

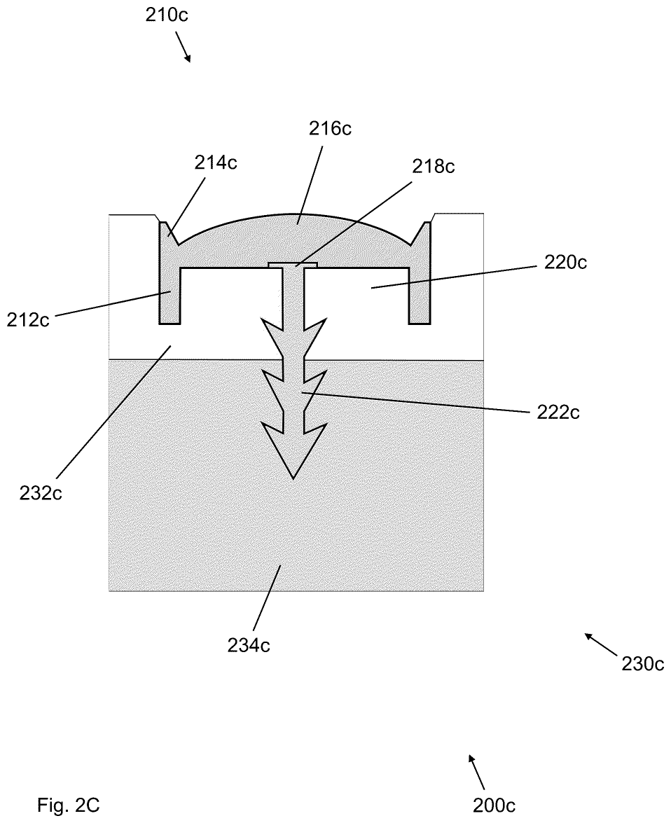

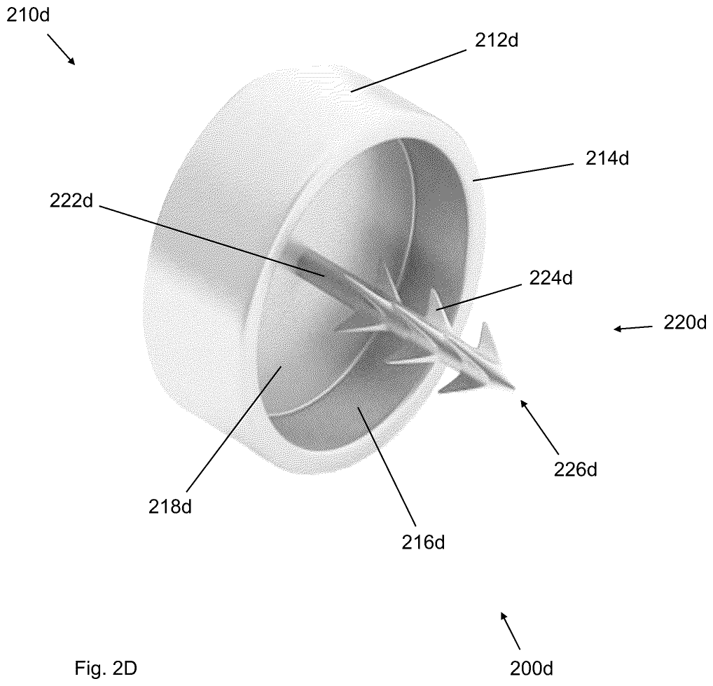

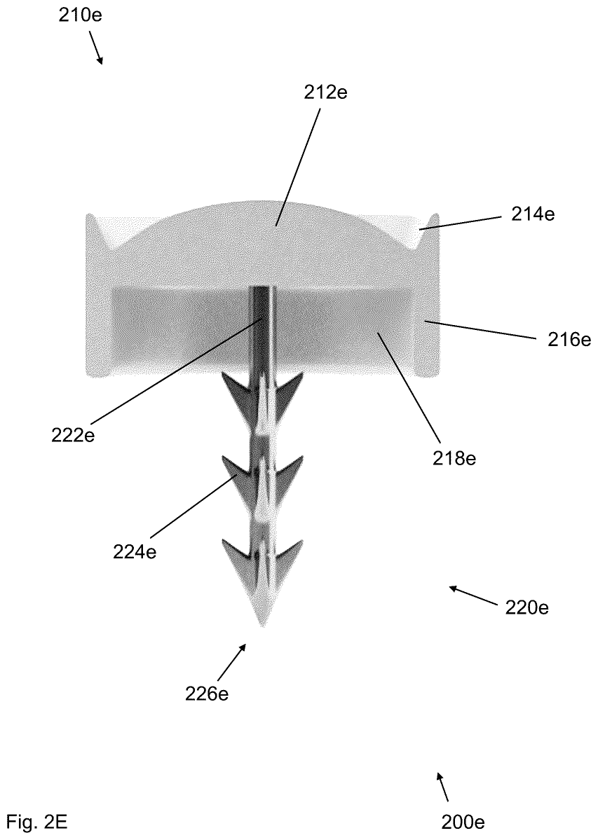

As shown in FIG. 2A, a top perspective view of a drywall button fastener 200a is provided. The drywall button fastener 200a may comprise a retention button portion 210a and a nail element portion 220a. The retention button portion 210a may be robustly coupled at a bottom portion surface to a top terminal end of the nail element portion 220a. In some embodiments, the retention button portion 210a may be removably coupled to the nail element portion 220a.

The retention button portion 210a may comprise an upper lip 212a circumferentially disposed around a button portion 214a. The button portion 214a may further be encircled by a retaining wall 216a that partially forms the upper lip 212a. While an outer portion of the upper lip 212a is defined by the top terminal portion of the retaining wall 216a, the inner portion of the upper lip 212a may comprise a tapered structure that slopes down and in toward the button portion 214a as shown in FIG. 2A. An upper exterior surface of the button portion 214a may be coupled to an exterior surface of the upper lip 212a as shown.

The nail element portion 220a may extend downwardly from its point of coupling to the retention button portion 210a. The nail element portion 220a may comprise a nail shaft portion 222a, a plurality of back hooks 224a and a pointed tip end 226a. The nail shaft portion 222a may extend vertically downward from a shank at the top terminal end of the nail element portion 220a to the pointed tip end 226a at the bottom terminal end of the portion 220a. The nail shaft portion 222a may comprise the plurality of back hooks 224a protruding therefrom in a manner symmetric about the circumference of the cylindrical nail shaft portion 222a. The pointed tip end 226a may be disposed at the bottom terminal end of the nail element portion 220a and may be at least partially formed by the structure of the plurality of back hooks 224a as shown in FIG. 2A.

As shown in FIG. 2B, an elevational view of a drywall button fastener 200b is provided. The drywall button fastener 200b may comprise a retention button portion 210b and a nail element portion 220b. The retention button portion 210b may be robustly coupled at a bottom portion surface to a top terminal end of the nail element portion 220a. More specifically, the head of the nail element portion 220b may be retained within the body of retention button portion 210b.

The retention button portion 210b may comprise a button portion 212b having at least a partial hemispherical dome shape that extends above a cylindrical retaining wall 214b as shown in FIG. 2B. The button portion 212b may further be encircled by the cylindrical retaining wall 214b that partially forms an upper lip at top portion thereof. While the retaining wall 214b is described as being cylindrical, it may be structured to be cylindrical in part and annular in part to allow a cavity to be formed within which the nail element portion 220b may be coupled inside of the body of the button portion 212b as shown in FIG. 2B.

The nail element portion 220b may extend downwardly from its point of coupling to the retention button portion 210b. The nail element portion 220b may comprise a nail shaft portion 222b, a plurality of back hooks 224b and a pointed tip end 226b. The shaft portion 222b may be considered to be a unitary element with a cylindrical shape around which sets of back hooks 224b are disposed in a symmetric manner both axially and radially. Alternatively, the shaft portion 222b may be considered to comprise a plurality of shaft portions 222b disposed between sets of back hooks 224b where the shaft portions 222b are disposed symmetric along the length of the nail element portion 220b from the head to the pointed tip end 226b.

As shown in FIG. 2C, a cross-sectional view of a drywall button fastener 200c coupling a drywall panel 232c to a stud 234c is provided. The drywall button fastener 200c may comprise a retention button portion 210c and a nail element portion comprising a nail head 218c and a shaft portion 222c. The retention button portion 210c may be robustly coupled to a top terminal end of the nail head 218c of the nail element portion. Specifically, the nail head 218c may be retained within a cavity 220c formed within the body of a retention button portion 210c. The nail head 218c may be secured within the cavity 220c via a snap-fit or a press-fit coupling.

Alternatively, the retention button portion 210c and the nail element portion may be produced from the same material and thereby fabricated as a monolithic seamless unitary structure. In some embodiments, the production material may be a metal, a polymer or any other class of materials capable of being injected or poured into a mold for subsequent curing and removal from the mold for use. In such an alternative configuration, the nail head 218c will be unitary with the body of the button portion 216c and therefore is not distinguishable from the remainder of the retention button portion 210c.

The retention button portion 210c may comprise a button portion 216c having at least a partial hemispherical dome shape that extends slightly above an upper lip 214c of a cylindrical retaining wall 212c as shown in FIG. 2C. The button portion 216c may further be encircled by the cylindrical retaining wall 212c and the upper lip 214c. Additionally, the cylindrical retaining wall 212c along with the body of the button portion 216c may form the cavity 220c that accepts the shaft portion 222c of the nail element portion therein.

In use, the retention button portion 210c may be struck by the anvil of the drywall button gun 100 of FIG. 1 when the nail element portion is adjacent a work area 230c. Specifically, upon the anvil striking the upper lip 214c and the button portion 216c, the pointed tip end of the nail element portion is driven through the top surface of the drywall panel 232c into the body of the stud 234c as shown in FIG. 2C. Further, this process also drives the cylindrical retaining wall 212c through the top surface of the drywall panel 232c and into the body thereof without breaching the surface of the study 234c. As such, the cavity 220c defined by the cylindrical retaining wall 212c accepts a portion of the body of the drywall panel 232c therein and the wall 212c acts an additional means of securing the drywall button fastener 200c within both the drywall panel 232c and the stud 234c which in turn keeps the fastener 200c from popping and the drywall panel 232c itself from popping.

As shown in FIG. 2D, a bottom perspective view of a drywall button fastener 200d is provided. The drywall button fastener 200d may comprise a retention button portion 210d and a nail element portion 220d. The retention button portion 210d may be robustly coupled to a top terminal end of the nail element portion 220d. Specifically, a shank portion 222d of the nail element portion 220d may extend into the body of the retention button portion 210d as shown.

Moreover, the nail element portion 220d may be retained and enveloped within a bottom surface 218d of a button portion of the retention button portion 210d as shown in FIG. 2D. The bottom surface 218d along with an interior wall surface 216d may define a partial cylindrical cavity through which the nail element portion 220d passes. The nail element portion 220d may be secured to the retention button portion 210d via one or more of a snap-fit coupling, a press-fit coupling, a monolithic seamless unitary molded fabrication and the like or any combination thereof.

The retention button portion 210d may comprise an outer wall surface 212d, a lip surface 214d, the interior wall surface 216d and the bottom surface 218d. The outer wall surface 212d, the lip surface 214d and the interior wall surface 216d may collectively form, in part, a cylindrical retaining wall. The nail element portion 220d may comprise the shank portion 222d, a plurality of sets of symmetrically-spaced back hooks 224d and a pointed tip end 226d. The plurality of sets of symmetrically-spaced back hooks 224d may be symmetrically spaced along the length of the nail element portion 220d and along the radial circumference of the nail element portion 220 as shown in FIG. 2D.

As shown in FIG. 2E, a partial cross-section elevational view of a drywall button fastener 200e is provided. The drywall button fastener 200e may comprise a retention button portion 210e and a nail element portion 220e. The retention button portion 210e may comprise a button portion 212e, an upper lip 214e, a cylindrical retaining wall 216e and an inner cylindrical surface 218e partly defining a cavity therein as shown. The nail element portion 220e may comprise a shank portion 222e, a plurality of sets of symmetrically-spaced back hooks 224e and a pointed tip end 226e.

The plurality of sets of symmetrically-spaced back hooks 224e may be such that each set comprises at least two back hooks but no more than six back hooks, all of which are symmetrically spaced about a radial circumference of a shaft portion of the nail element portion 220e. Any number of back hooks less than two would not serve the purpose of evenly distributing the structural resistive forces of the drywall panel and stud across the horizontal cross-section of the nail element portion 220e. For this same reason, it is advantageous that the at least two back hooks be symmetrically spaced about the radial circumference of the shaft portion of the nail element portion 220e. Further, any number of back hooks greater than six would not only be difficult and costly to manufacture on a mass scale but also would provide structural barriers to properly insert the drywall button fastener 200e into the drywall panel and stud. Moreover, a number of back hooks greater than six may present such a physical barrier to entry into the drywall panel and stud that any successful entry therein would require an entry cavity being formed that too severely degrades the structure of the drywall panel and/or the stud.

Generally, the button portion of the drywall button fastener of any of the embodiments described herein may comprise at least a partially hemispherical shape. Specifically, the radius of curvature of the at least partially hemispherical shape may fall between a range of 0 and 10 inches, but more preferably between a range of 1.5 inches and 6 inches. Radius of curvature values greater than 6 inches provide a button portion that is too flat to structurally hold up against the impact force of the gun anvil. Further, radius of curvature values less than 1.5 inches provide a button portion that is too curved such that it does not present an adequately flat enough striking surface for the gun anvil which decreases the ease of use of the drywall button fastener. Therefore, the range of values of the radius of curvature of the button portion between 1.5 inches and 6 inches is critical to the functionality of the drywall button fastener.

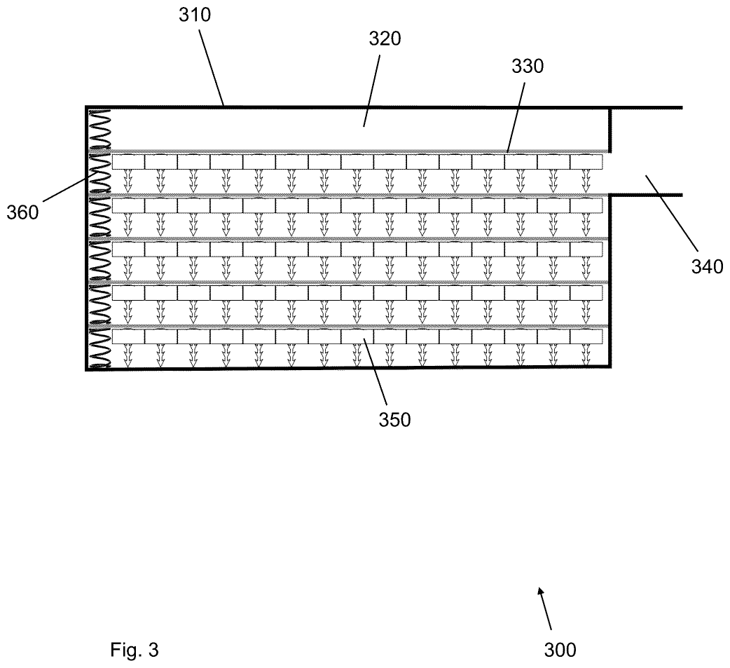

As shown in FIG. 3, a detailed elevational view of the interior of a magazine 300 of a drywall button gun for dispensing a plurality of a drywall button fasteners is provided. The magazine 300 may comprise a magazine housing 310, a plate storage area 320, a plurality of fastener row plates 330, a feed chamber 340, a plurality of drywall button fasteners 350 and a plurality of structural resistance springs 360. The magazine 300 may be utilized within the drywall button gun as previously described with reference to FIG. 1.

The magazine housing 310 may define a cavity within which the plate storage area 320, the plurality of fastener row plates 330, the plurality of drywall button fasteners 350 and the plurality of structural resistance springs 360 are contained. The plate storage area 320 may be utilized to store, in a stacked configuration, expended fastener row plates 330 upon all of the drywall button fasteners 350 in that row being expended into the feed chamber 340. The plurality of structural resistance springs 360 may be utilized between each successive row of plates 330 and fasteners 350 in order to maintain each row in the precise position for proper loading into the feed chamber 340 and thereafter for ejection from the ejection port of the drywall button gun via the anvil.

Each row of drywall button fasteners 350 may be aligned side by side in a vertical configuration such that each outer wall surface of the cylindrical retaining wall of a given fastener 350 is aligned adjacent the outer wall surface of a successive fastener 350 in the row as shown in FIG. 3. In operation, the movement of the anvil of the drywall button gun may actuate a slide reload mechanism which in turn actuates a rotating feed within the feed chamber 340 that propels the next drywall button fastener 350 into the ejection chamber of the drywall button gun.

Each of the drywall button fasteners 350 in each row may be coupled to successive drywall button fasteners via a breakaway coupling segment. The breakaway coupling segment may be structurally monolithic and materially uniform with the button portions of each drywall button fastener 350 such that rows of button portions may be mass fabricated with a breakaway coupling segment structurally connecting each successive button portion.

In use, a row of fabricated drywall button fasteners 350 may be disposed in a coiled configuration between fastener row plates 330 within the magazine housing 310. Therefore, it would be advantageous for the breakaway coupling segment to be fabricated from a material that is flexible when produced at the dimensions of the breakaway coupling segment. However, such fabrication materials may also be used for the button portions which require a material robust enough to endure the force impact of the drywall gun's anvil. Therefore, advantageous fabrication materials for the button portion and breakaway coupling segment satisfying both requirements include lightweight metals such as aluminum, steel, titanium and any alloys or combinations thereof as well as robust polymers such as polyoxymethylene and like polymers. In some embodiments, the nail element portion of the drywall button fastener may be advantageously fabricated from brittle steel which utilizes roughly ⅓ of the amount of steel of nail element portions fabricated with standard grade steel, thereby reducing the fabrication material cost in producing the drywall button fastener.

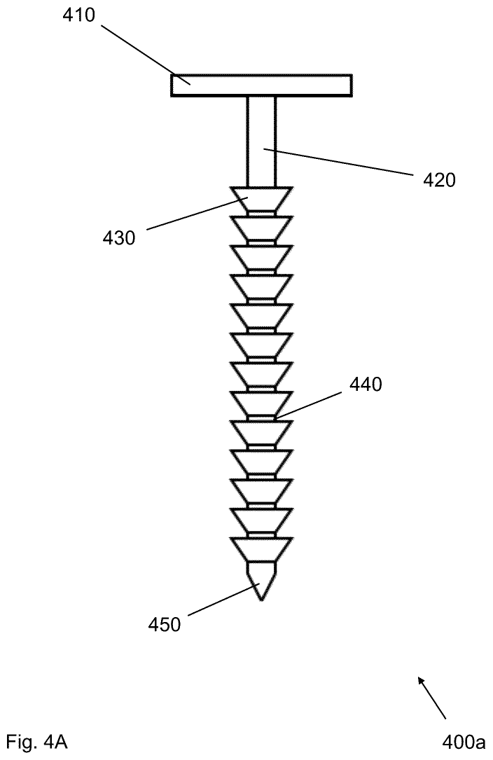

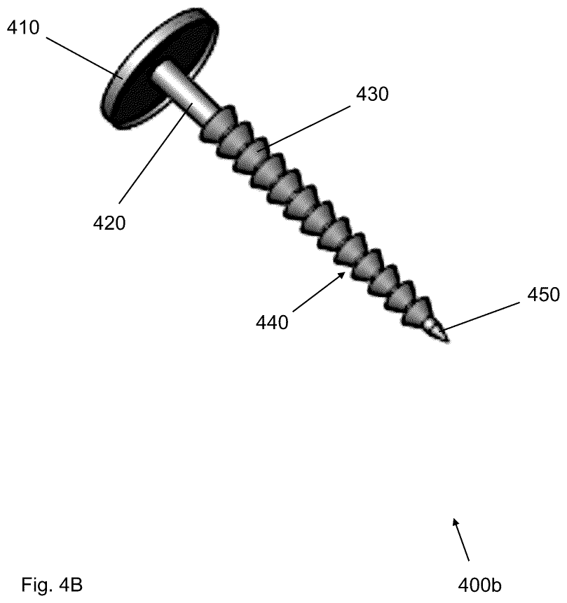

As shown in FIG. 4A, an elevational view of a nail element portion 400a of a drywall button fastener having cylindrical back hooks 430 is provided. The nail element portion 400a may comprise a nail head 410, a nail shank 420, a plurality of successively arranged conical back hooks 430, a plurality of successively arranged shank spacer portions 440 and a pointed tip end 450. While the nail head 410, nail shank 420 and pointed tip end 450 are either similar or identical to that of the nail element portions disclosed in FIGS. 2A-2E, the plurality of successively arranged conical back hooks 430 and the plurality of successively arranged shank spacer portions 440 are structurally modified relative the nail element portions of FIGS. 2A-2E to have unique advantages in certain contexts.

Specifically, the plurality of conical back hooks 430 are structured to flare outwards from the nail shank 420 and the plurality of shank spacer portions 440 that define the nail shaft as shown in FIG. 4A. The outward flare of the conical back hooks 430 may be at an angle of between 15 degrees and 60 degrees, but preferably between 25 degrees and 50 degrees and more preferably between 30 degrees and 45 degrees. The angle range between 30 degrees and 45 degrees is advantageous in that it provides the ideal ratio of the threshold removal force to the threshold PSI insertion force. Specifically, the angle range between 30 degrees and 45 degrees provides a high pull force (relative angle ranges below 30 degrees) required to remove the nail element portion 400a from its lodged position through the drywall panel and stud. Further, the angle range between 30 degrees and 45 degrees doesn't provide too high of a PSI insertion force (relative angle ranges above 45 degrees) required to insert the nail element portion 400a through the drywall panel and stud. Moreover, angle ranges below 15 degrees do not provide a high enough threshold removal force which may lead to the drywall panel popping off of the stud which runs counter to at least one aspect of the novelty and purpose of this invention. Angle ranges above 60 degrees provide too high of a threshold PSI insertion force which may lead to unnecessary effort and energy expended (which the given drywall gun may not even be able to provide) in order to install the drywall button fastener into the drywall and stud.

Further, the length of the nail shaft, as defined by the length between the nail head 410 and the pointed tip end 450, may comprise a critical value within the range between 1 inch and 2.25 inches, but more preferably between 1.25 inches and 2 inches. Specifically, nail shaft length values falling below 1.25 inches may not be long enough to fully penetrate drywall panels having the common thickness values of between ¼ inch and ⅝ inch in addition to the stud therebehind which leaves the drywall panel unsecured and defeats the purpose of the nail element portion 400a. Additionally, nail shaft length values beyond 2 inches may be too long such that they fully penetrate the drywall panel and the stud which may cause damage to the structural integrity of the stud and/or the building materials disposed beyond the stud. Therefore, the length value range of between 1.25 inches and 2 inches of the nail shaft is a critical range in almost every use case application of the nail element portion 400a.

Moreover, the number of conical back hooks 430 successively disposed along the nail shaft may fall within the critical value range of between 10 and 50 conical back hooks, but more preferably between 15 and 30 conical back hooks. Specifically, a number of back hooks less than 15 will likely not provide a high enough removal force required to remove the drywall panel from the stud which may lead to the drywall panel popping off of the stud. Further, a number of back hooks greater than 30 will likely provide too high of a removal force required to remove the drywall panel from the stud and further will require an overly complex fabrication process that adds too much cost to the nail element portion 400a relative the value gained by the increased number of back hooks. Therefore, the range of between 15 and 30 conical back hooks is a critical range for optimizing the utility and fabrication cost of the nail element portion 400a.

As shown in FIG. 4B, a perspective view of a nail element portion 400b of a drywall button fastener having cylindrical back hooks 430 is provided. The nail element portion 400b may comprise a nail head 410, a nail shank 420, a plurality of successively arranged conical back hooks 430, a plurality of successively arranged shank spacer portions 440 and a point tip end 450. Similar to FIG. 4A, the nail head 410, nail shank 420 and pointed tip end 450 are either similar or identical to that of the nail element portions disclosed in FIGS. 2A-2E.

One advantage of the nail element portion 400b of FIG. 4B are the shape and structure of the conical back hooks 430. For instance, each conical back hook 430 may flare outwards from the nail shank 420 and shank spacer portions 440 of the nail shaft back towards the nail head 410. The conical shape of the back hooks 430 may comprise a solid conical structure or an annular hollow conical structure. A solid conical structure may be advantageous when a more robust securement is desired such when the nail element portion 400b is being driven into a metallic structure. A hollow conical structure may be advantageous when it is desired to minimize the cost of fabrication material for the nail element portion 400b. Further, the hollow conical structure allows softer substrates like wood to expand into the cavities for the annular conical structure of the back hooks 430 which provides an increase in the threshold removal force of the inserted nail element portion 400b.

The specification and drawings are to be regarded in an illustrative rather than a restrictive sense. However, it will be evident that various modifications and changes may be made thereunto without departing from the broader spirit and scope of the invention as set forth in the claims. Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

All features disclosed in the specification, claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Throughout this disclosure, the phrase ‘modularly coupled’ and similar terms and phrases are intended to convey that any element of a given class of elements may be coupled to another given element and vice versa with equal effect. For example, any extension cord of a plurality of extension cords may be modularly coupled to another extension cord and vice versa with equal effect. Further, throughout this disclosure, the phrase ‘removably coupled’ and similar terms and phrases are intended to convey that a given element may be iteratively coupled to and removed from another given element as desired. For example, a male plug of a first extension cord may be removably coupled to a female plug of a second extension cord as desired.

The use of the terms “a,” “an,” “the,” and similar referents in the context of describing the disclosed embodiments (especially in the context of the following claims) are to be construed to cover both the singular and the plural, unless otherwise indicated or clearly contradicted by context. The terms “comprising,” “having,” “including,” and “containing” are to be construed as open-ended terms (i.e., meaning “including, but not limited to,”) unless otherwise noted. The term “coupled” or “connected,” where unmodified and referring to physical connections, is to be construed as partly or wholly contained within, attached to, or joined together, even if there is something intervening. Recitation of ranges of values are merely intended to serve as a shorthand method of referring individually to each separate value falling within the range, unless otherwise indicated and each separate value is incorporated into the specification as if it were individually recited. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal.

Conjunctive language, such as phrases of the form “at least one of A, B, and C,” or “at least one of A, B and C,” is understood with the context as used in general to present that an item, term, etc., may be either A or B or C, or any nonempty subset of the set of A and B and C, unless specifically stated otherwise or otherwise clearly contradicted by context. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). The number of items in a plurality is at least two, but can be more when so indicated either explicitly or by context.

The use of any examples, or exemplary language (e.g., “such as”) provided, is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described, including the best mode known to the inventors for carrying out the invention. Variations of those embodiments may become apparent to those of ordinary skill in the art upon reading the foregoing description. The inventors expect skilled artisans to employ such variations as appropriate and the inventors intend for embodiments of the present disclosure to be practiced otherwise than as specifically described. Accordingly, the scope of the present disclosure includes all modifications and equivalents of the subject matter recited in the claims appended hereto as permitted by applicable law. Moreover, although above-described elements may be described in the context of certain embodiments of the specification, unless stated otherwise or otherwise clear from context, these elements are not mutually exclusive to only those embodiments in which they are described; any combination of the above-described elements in all possible variations thereof is encompassed by the scope of the present disclosure unless otherwise indicated or otherwise clearly contradicted by context.

All references, including publications, patent applications, and patents, cited are hereby incorporated by reference to the same extent as if each reference were individually and specifically indicated to be incorporated by reference and were set forth in its entirety.

1. A drywall fastening button device, comprising:
a retention button portion comprising an upper lip, a button portion and a retaining wall, wherein:
the retaining wall surrounds the button portion, and
the upper lip is disposed at a top terminal end of the retaining wall; and
a nail element portion comprising a shaft portion, a plurality of back hooks and a pointed tip end, wherein:
the shaft portion extends from the retention button portion,
the plurality of back hooks extend outward from the shaft portion, and
the pointed tip end is disposed at a bottom terminal end of the nail element portion.

2. The drywall fastening button device of claim 1, wherein the retention button portion and the nail element portion are robustly coupled together via the shaft portion.

3. The drywall fastening button device of claim 1, wherein the retention button portion and the nail element portion are robustly coupled together via a nail head of the nail element portion.

4. The drywall fastening button device of claim 1, wherein the retention button portion and the nail element portion each comprise identical metallic fabrication materials.

5. The drywall fastening button device of claim 1, wherein the retention button portion comprises a polymer fabrication material and the nail element portion comprises a brittle steel fabrication material.

6. The drywall fastening button device of claim 1, wherein the retention button portion and the nail element portion are fabricated from the same material together as a monolithic seamless unitary structure.

7. The drywall fastening button device of claim 1, wherein the retention button portion comprises a bottom surface.

8. The drywall fastening button device of claim 7, wherein the retaining wall comprises an interior wall surface.

9. The drywall fastening button device of claim 8, wherein a cavity is defined by the bottom surface and the interior wall surface.

10. The drywall fastening button device of claim 9, wherein the shaft of the nail element portion passes through the cavity.

11. The drywall fastening button device of claim 10, wherein a nail head of the nail element portion is disposed within the bottom surface.

12. The drywall fastening button device of claim 1, wherein the shaft portion comprises a shank disposed between a bottom surface of the retention button portion and the plurality of back hooks.

13. The drywall fastening button device of claim 12, wherein the plurality of back hooks are disposed between the shank and the pointed tip end.

14. The drywall fastening button device of claim 1, wherein a plurality of shank spacer portions are disposed axially along the shaft portion between successive back hooks of the plurality of back hooks.

15. The drywall fastening button device of claim 1, wherein a first retention button portion of a first drywall fastening button device is coupled to a second retention button portion of a second drywall fastening button device.

16. The drywall fastening button device of claim 15, wherein the first retention button portion and the second retention button portion are fabricated from the same material together as a monolithic seamless unitary structure.

17. The drywall fastening button device of claim 15, wherein the first retention button portion and the second retention button portion are coupled together via a breakaway coupling segment.

18. The drywall fastening button device of claim 15, wherein:
the second retention button portion is coupled to a third retention button portion of a third drywall fastening button device; and
the second retention button portion is disposed in series between the first retention button portion and the third retention button portion.

19. A drywall fastening button device, comprising:
a retention button portion comprising an upper lip, a button portion and a retaining wall, wherein:
the retaining wall surrounds the button portion, and
the upper lip is disposed at a top terminal end of the retaining wall; and
a nail element portion comprising a shaft portion, a plurality of back hooks and a pointed tip end, wherein:
the shaft portion extends from the retention button portion,
the plurality of back hooks extend outward from the shaft portion,
the pointed tip end is disposed at a bottom terminal end of the nail element portion, and
the shaft portion comprises a shank disposed between a bottom surface of the retention button portion and the plurality of back hooks.

20. A drywall fastening button device, comprising:
a retention button portion comprising an upper lip, a button portion and a retaining wall, wherein:
the retaining wall surrounds the button portion, and
the upper lip is disposed at a top terminal end of the retaining wall; and
a nail element portion comprising a shaft portion, a plurality of back hooks and a pointed tip end, wherein:
the shaft portion extends from the retention button portion,
the plurality of back hooks extend outward from the shaft portion,
the pointed tip end is disposed at a bottom terminal end of the nail element portion,
the shaft portion comprises a shank disposed between a bottom surface of the retention button portion and the plurality of back hooks,
the plurality of back hooks are disposed between the shank and the pointed tip end, and
a plurality of shank spacer portions are disposed axially along the shaft portion between successive back hooks of the plurality of back hooks.
